(19) United States
(12) Patent Application Publication
(10) Pub. No.: US 2014/0372805 A1
(43) Pub. Date: Dec. 18, 2014

(54) SELF-HEALING MANAGED CUSTOMER PREMISES EQUIPMENT

(71) Applicant: Verizon Patent and Licensing Inc., Arlington, VA (US)

(72) Inventors: Jan Marcel Rijnders, Leiden (NL); Neil Ronketti, Soham (GB); Christopher A. Kimm, Morristown, NJ (US)

(21) Appl. No.: 14/459,857

(22) Filed: Aug. 14, 2014

Related U.S. Application Data
(63) Continuation-in-part of application No. 13/664,741, filed on Oct. 31, 2012.

(51) Int. Cl. G06F 11/07; G06Q 10/06

(52) U.S. Cl. CPC G06F 11/0793; G06Q 10/06311
USPC 714/37

(57) ABSTRACT

A system comprising at least one controller including a controller processor with a memory configured to execute self-healing rules. The self-healing rules may include at least one corrective measure and at least one failure symptom. The system may include an automated incident management device including a central processor with a memory to receive service management information from the at least one controller, correlate at least one corrective measure with at least one failure symptom, adjust the self-healing rules based on the correlation, and propagate the adjusted self-healing rules to the at least one controller.

### CROSS-REFERENCE TO RELATED APPLICATIONS

This continuation-in-part application is based on and claims priority to U.S. patent application Ser. No. 13/664,741, filed Oct. 31, 2012, titled “ADVANCED MANAGED SERVICE CUSTOMER EDGE ROUTER,” which is hereby incorporated by reference in its entirety.

### BACKGROUND

A customer may choose to outsource management of its information technology (IT) resources to a network service provider. For example, a network service provider may offer managed telecommunications and data services to customers who lack the skill or inclination to manage those services themselves. IT services managed at least in part by a network service provider may be referred to as managed services. To provide managed services to the customer, the network service provider may set up equipment at a remote location such as a customer site, and may implement appropriate settings on the equipment and the network. To maintain managed services, the network service provider may monitor the equipment at the customer site, and may assign personnel to trouble tickets to address any identified issues.

Although the network service provider may perform a number of functions to identify issues and resolve trouble tickets, many trouble tickets may require the services of network service personnel. The costs incurred by the network service provider in addressing these trouble tickets may be substantial. In some cases, the network service provider may request customer involvement in issue troubleshooting, which may be inconvenient or unwelcome by the customer receiving the managed services.

### BRIEF DESCRIPTION OF THE DRAWINGS

FIG. 1 illustrates an exemplary network implementation of a communications system configured to provide managed services to a customer site;

FIG. 2 illustrates an exemplary network implementation of a communications system configured to provide managed services to a customer site including a managed services edge device;

FIG. 3A illustrates an exemplary network implementation of a communications system configured to provide managed services to a customer site including a managed services router;

FIG. 3B illustrates an exemplary network implementation of a communications system configured to provide managed services to a customer site including an alternate managed services router;

FIG. 4 illustrates an exemplary network implementation of a communications system configured to provide managed services to a customer site including an alternate managed services edge device;

FIG. 5 illustrates an exemplary process for customer equipment configured to monitor managed services at a customer site;

FIGS. 6A and 6B illustrate an exemplary process for an automated incident management device configured to monitor managed services at customer sites;

FIG. 7 illustrates an exemplary process for an automated incident management device configured to set up customer equipment;

FIG. 8 illustrates an exemplary process for applying self-healing rules;

FIG. 9 illustrates an exemplary process for adjusting self-healing rules between an automated incident management system and a plurality of remote controllers;

FIG. 10 illustrates an exemplary process for a fault tree analysis, for example, associating failure symptoms with fault conditions; and

FIG. 11 illustrates an exemplary process for correlating self-healing rules between a controller and an automated incident management system.

### DETAILED DESCRIPTION

A managed service may involve equipment of a network service provider working in combination with equipment co-located at a remote location such as a customer site. Equipment co-located at the remote location may be owned by a customer or another entity such as the network service provider, but may be referred to herein as customer equipment. While maintenance of aspects of the managed service may fall on the network service provider, the customer may bear some responsibility such as to ensure that the customer equipment is properly stored and powered.

An automated incident management device may be configured to provide for automatic generation of trouble tickets for issues that occur at the customer site. These may include issues that should be addressed by the customer such as loss of power or a pulled cable, or issues that should be addressed by the network service provider such as network configuration errors or equipment failures.

The automated incident management device may be configured to receive a message from an item of customer equipment at a customer site indicating a potential issue with a managed service. The message may be used by the automated incident management device to generate a trouble ticket or to add information to an existing trouble ticket associated with the customer site. To diagnose and resolve the trouble ticket, the automated incident management device may be further configured to connect to an item of customer equipment by way of a secondary network connection to the customer site. The secondary network connection may include, for example, an alternate or backup network connection over a public switched telephone network (PSTN) link or a wireless connection over a cellular data network. The secondary connection may be used to ensure that the customer site maintains network connectivity despite a failure of a primary communications link.

The automated incident management device may be configured to retrieve information from the customer equipment, for example, by way of the secondary network connection. Exemplary information may include a status of a power source configured to power the item of customer equipment, data from a temperature sensor configured to provide temperature information for the environment in which the customer equipment is placed, and log data from devices at the customer site (e.g., router logs).

The automated incident management device may be further configured to attempt a corrective measure based on the retrieved information. For instance, the automated incident management device may be configured to provide for the remote rebooting of equipment at the customer site. The corrective measures may be performed according to rules that specify corrective measures likely to resolve the trouble ticket. As an example, the rules may specify that if an item of equipment is determined to have an issue, then that item of equipment (and potentially additional items of equipment) may be rebooted or otherwise reset. As another example, the rules may specify corrective measures to be performed that are likely to resolve the trouble ticket based on prior history, such as, that if a trouble ticket presents as being similar to a historical trouble ticket, then the rules may determine to apply corrective measures similar to those that addressed the historical trouble ticket. The automated incident management device may also be configured to update the trouble ticket associated with the customer site responsive to the attempted corrective measure.

In some examples, the automated incident management device may be configured to periodically check a status of the item of customer equipment to determine whether the customer equipment is experiencing an issue. For example, the automated incident management device may generate a message if an item of customer equipment (e.g., a router) cannot be reached for a predetermined duration. As another example, the automated incident management device may receive a message from customer equipment upon loss of primary power or network connectivity. As yet a further example, the automated incident management device may analyze information retrieved from the customer equipment, such as router log files, to determine that one or more devices at the customer site are no longer functioning properly.

In some examples, either message may be sufficient to generate a trouble ticket. As another approach, the automated incident management device may be further configured to correlate messages received from the customer equipment with the periodic polled status of the customer equipment, and to create a trouble ticket associated with the customer site when both the automated incident management device and the customer site both indicate the presence of an issue.

The automated incident management device may be further configured to ensure that only those trouble tickets within the network service provider's area of responsibility are assigned to network engineers for further assessment. Trouble tickets that are determined to be the responsibility of the customer may instead be identified to the customer for the customer to correct. For instance, the automated incident management device may be configured to determine that a power source down message was received from the customer site, and to update the trouble ticket to indicate that the trouble ticket is the result of a power issue that is the responsibly of the customer to repair, not the network service provider.

The secondary network connection to the automated incident management device may be configured to facilitate additional functionality in relation to the managed services. For instance, the automated incident management device may be configured to initiate an alternate or failover connection to the customer site by way of the secondary network connection, responsive to receipt of a message indicative of a customer issue with the managed service. The data may include configuration or log data from devices at the customer site (e.g., router logs). The backup data may also include a backup of customer data available over the WAN.

As another example of additional managed services functionality provided by way of the secondary network connection, the automated incident management device may be further configured to allow for the remote setup and configuration of the customer equipment. For example, a service provider may provide customer equipment to a customer for placement at the customer site. When installed, the customer equipment may be auto-discovered by the automated incident management device, allowing for a registration process to be triggered. Identification of the customer equipment may be based on a hardware token or other value made available by the customer equipment. In some cases the automated incident management device or a remote provisioning service may be further configured to confirm that the customer equipment belongs to the customer network wherein it is being installed, such as according to the network location of the customer equipment. The remote provisioning service may be configured to manage delivery of service, load configurations to customer premises equipment, or provision communication services (e.g., add, remove, or modify service). The automated incident management device or the remote provisioning service may further be configured to provide configuration information to the customer equipment, perform turn-up testing on the customer equipment upon receipt of the configuration information, and if successful, enabling the monitoring of the customer equipment for issues once configured.

The automated incident management device may be communicatively connected to any portion of the system, for example to receive or send data (e.g., backup, configuration, or log information) with respect to any portion of the system. The automated incident management device may also be operatively connected to any portion of the system, for example, to receive or send commands with respect to any portion of the system, for example, one or a plurality of controllers at one or a plurality of customer sites.

The system (e.g., the automated incident management device, a controller of a customer site, or a combination thereof) may further be configured to execute automated repair operations in response to system issues, which may be referred to herein as “self-healing.” For example, self-healing may be executed in response to a fault condition such as loss of connectivity. The self-healing rules may include one or more failure symptoms (e.g., associated the fault condition) and one or more corrective measures (e.g., to automatically repair the fault condition).

An automated incident management device may include memory and a central processor, for example, configured to receive service management information from or generated by one or more controllers. The service management information may include the self-healing rules and service performance information. The service management information may include information with respect to full or partial failures of the system. The service management information may be from at least one controller, which may be remote from incident management device. The service performance information may include any indicator of performance with respect to the system, for example a failure or success rate, a recover threshold, errors, race conditions, latency, and packet delivery or loss. The controller may include a controller processor with memory configured to execute self-healing rules for the automated repair or recovery of the system. The incident management device may include a central processor with memory configured to adjust the self-healing rules based on service management information received from one or a plurality of controllers, each of which may be remote from incident management device.

Each controller may be associated with a customer site and may include memory and a controller processor, for example, configured to execute the self-healing rules. The system (e.g., at least one of the controller and the automated incident management device) may be configured to generate a correlation between at least one corrective measure with at least one failure symptom, adjust the self-healing rules based on the correlation, and propagate the adjusted self-healing rules to one or a plurality of controllers at one or a plurality of customer sites. Thus, the self-healing rules may evolve based on the collective learning of the plurality of controllers at a plurality of customer sites. The collective learning may be based in part historic events with respect to the system and human inputs such as engineering best practices.

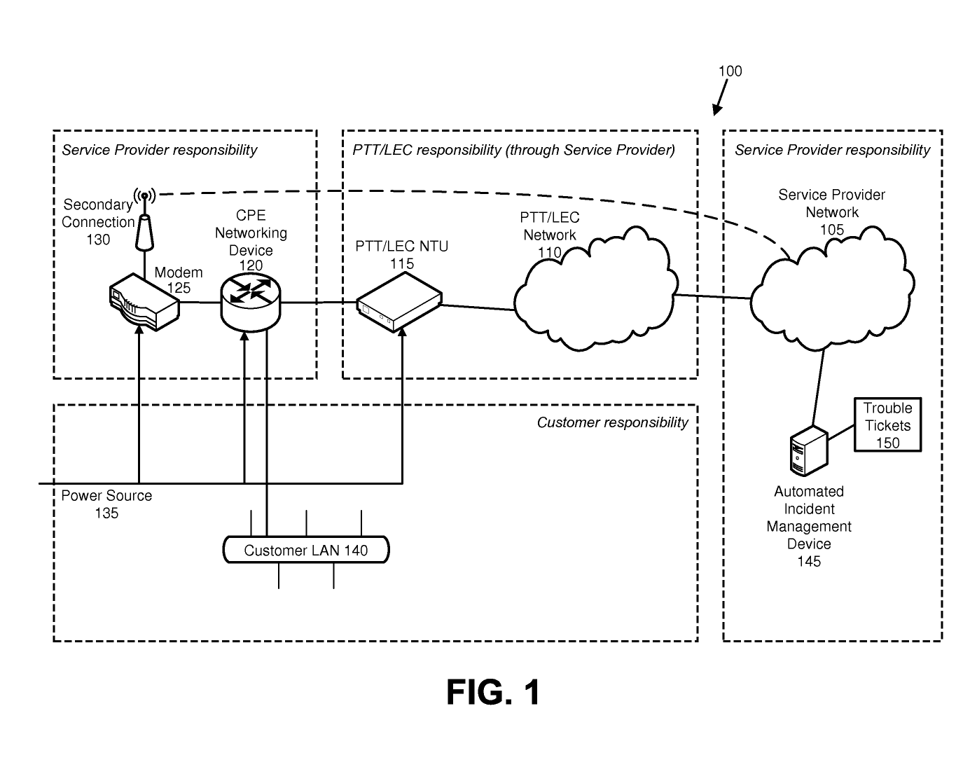

FIG. 1 illustrates an exemplary network implementation of a communications system 100 configured to provide managed services to a customer site. The system 100 may include a network service provider (NSP) network 105 and a PTT/LEC network 110 in communication with the NSP network 105. The system 100 may further include devices installed at a customer site, such as a PTT/LEC network terminating unit (NTU) 115, a customer-premises equipment (CPE) networking device 120 and a modem 125. These devices may be referred to as customer equipment, and may be powered by a power source 135 provided by the customer. The modem 125 may also be connected to a secondary network connection 130 providing additional functionality. The system 100 may further include a customer local area network (LAN) 140 taking advantage of the managed services being provided to the customer site. The system may also include an incident management device 145 in communication with the customer equipment at the customer site and configured to store trouble tickets 150 for the system 100. System 100 may take many different forms and include multiple and/or alternate components and facilities. While an exemplary system 100 is shown in FIG. 1, the exemplary components illustrated of the system 100 are not intended to be limiting. Indeed, additional or alternative components and/or implementations may be used.

The NSP network 105 may be configured to transport data between the customer site and other locations on the NSP network 105. The NSP network 105 may provide communications services, including packet-switched network services (e.g., Internet access, VoIP communication services) and circuit-switched network services (e.g., public switched telephone network (PSTN) services) to devices connected to the NSP network 105. Exemplary NSP networks 105 may include the PSTN, a VoIP network, a cellular telephone network, a fiber optic network, and a cable television network. To facilitate communications, communications devices on the NSP network 105 may be associated with unique device identifiers being used to indicate, reference, or selectively connect to the identified device on the NSP network 105. Exemplary device identifiers may include telephone numbers, mobile device numbers (MDNs), common language location identifier (CLLI) codes, Internet protocol (IP) addresses, input strings, and universal resource identifiers (URIs). In some cases, the NSP network 105 may be implemented as multiprotocol label switching (MPLS) network. A MPLS NSP network 105 may be configured to route data between sites, such as the customer site, according to path labels associated with the data, rather than by performing the routing according to other mechanisms such as routing lookup tables.

The PTT/LEC network 110 may be a relatively local communications network configured to connect to the NSP network 105 and provide communications services to customer sites by way of the NSP network 105. In some cases, the PTT/LEC network 110 may be provided by a local network service provider providing services to a geographical area including the customer site, while in other cases the PTT/LEC network 110 may be provided by a competing local exchange carrier leasing from the local provider and reselling the communications services.

The PTT/LEC NTU 115 may be configured to terminate a local access circuit, which the network service provider may order and provide via the PTT/LEC network 110. The PTT/LEC NTU 115 may accordingly provide a hand-off from the network service provider to the customer site device or devices. In some cases, the PTT/LEC NTU 115 may be owned by the PTT/LEC. However, due to location of the PTT/LEC NTU 115 at the customer site, power for the PTT/LEC NTU 115 may be provided by and be the responsibility of the customer. A large variety of NTU devices may be available on the market and deployed in PTT/LEC networks 110. Lacking a standard regarding the control of these devices, resetting a PTT/LEC NTU 115 may be achieved by the interruption of the power input to the PTT/LEC NTU 115. Some PTT/LEC networks 110 use line-powered PTT/LEC NTUs 115, so in such cases interruption of the communication line may be performed to force a reset of the PTT/LEC NTU 115. In other cases, a messaging or other protocol may be utilized to reset the PTT/LEC NTU 115.

The CPE networking device 120 may be configured to connect to the PTT/LEC NTU 115 at the customer site to provide the managed network services, and to selectively forward data between the NSP network 105 and the devices located at the customer site. The CPE networking device 120 may accordingly be used to access, receive, and use data transmitted over the NSP network 105, including configuration information associated with network services. The CPE networking device 120 may be capable of using network management protocols to communicate with other network devices over the NSP network 105. The CPE networking device 120 may include one or more devices configured to provide a connection by way of the NSP network 105. Exemplary CPE networking devices 120 may include modems, broadband network terminations, servers, switches, network interface cards, premises routers, routing gateways, and the like. As with the PTT/LEC NTU 115, power for the CPE networking device 120 may be provided by and be the responsibility of the customer.

The modem 125 may be configured to be in communication with the NSP network 105 by way of the PTT/LEC network 110 or a remote PTT/LEC network 110. In some cases, the modem 125 may be provided or owned by the network service provider, while in other cases the customer may acquire and use the customer's own equipment.

In addition to the connection to the NSP network 105, the modem 125 may also be connected to a secondary communications network by way of a secondary network connection 130. Exemplary secondary network connections 130 may include a PSTN connection through a PSTN phone line (e.g., customer or NSP owned) or a wireless connection through a cellular mobile access network. The modem 125 may utilize the secondary network connection 130 to provide a secondary access mechanism for telemetry or configuration purposes. For example, the secondary modem line may connect to a console port of the CPE networking device 120. The console port provides a higher privilege level to configure the CPE networking device 120, as compared to a reduced access level that may be available when accessing the CPE networking device 120 via the PTT/LEC NTU 115. In some cases, the modem 125 may utilize the secondary network connection 130 (or another secondary network connection 130) to provide communication services to the customer site when the primary PTT/LEC network 110 is unavailable. In some cases, the secondary network connection 130 may be the responsibility of the PTT/LEC, while in other cases the secondary network connection 130 may be provided or handled by a different provider of networking services.

The power source 135 may include a source of electric power provided by the customer to one or more of the PTT/LEC NTU 115, CPE networking device 120, modem 125, and customer LAN 140. In many cases, the terms of service for the managed services subscribed to by the customer specify that the customer should have an uninterruptible power supply (UPS) unit at the customer site. However, customers may omit this added item of equipment, which may cause interruptions to power provided to the devices at the customer site, and thereby cause outages and trouble tickets 150 to be created.

The customer LAN 140 may include one or more customer devices under the control of the customer and taking advantage of the managed services. For example, computers, tablets, servers, VoIP phones, and other devices may take advantage of the managed services provided by way of the service provider via the service provider network.

The incident management device 145 may be configured to facilitate the monitoring of the equipment located at the customer site that is used for the provisioning of the managed services to the customer. For example, the incident management device 145 may periodically retrieve the status of the CPE networking device 120 located at the customer site to verify the proper operation of the CPE networking device 120.

The incident management device 145 may be configured to maintain trouble tickets 150 associated with the plurality of customer sites. Each trouble ticket 150 may be associated with an identifier, such as an identifier of a CPE networking device 120 or of another device at the customer site having an issue, an identifier of the user associated with the customer site, or an identifier of the managed services account associated with the customer site. Trouble tickets 150 may further include additional information, such as a time at which an incident occurred or was reported, and any additional information available about the potential repair. Trouble tickets 150 may also be associated with status indicators indicative of the status of the trouble ticket 150. For instance, a trouble ticket 150 may be associated with an unassigned status when it is created. The trouble ticket 150 may be assigned a network service provider working status when it is assigned to support personnel. The trouble ticket 150 may be assigned a customer time status when it is associated with an issue that requires action on the part of the customer of the managed service. The trouble ticket 150 may be assigned to a completed or resolved status when the issue has been fully addressed.

The incident management device 145 may be further configured to automatically generate a trouble ticket 150 if the customer equipment cannot be reached for a certain duration or when a message is received from the customer equipment. The incident management device 145 may be further configured to notify the customer when a trouble ticket 150 is generated.

The incident management device 145 may be further configured to perform corrective measures to resolve the trouble ticket 150. For instance, the automated incident management device may be configured to provide for the remote rebooting of equipment at the customer site. The corrective measures may be performed according to rules that specify which corrective measures are likely to resolve the trouble ticket 150. For example, the rules may specify that if an item of equipment is determined to be having an issue, then that item of equipment may be rebooted. The rules may further specify that an item of equipment related to the item of equipment determined to be having an issue should also be rebooted. For example, if a CPE networking device 120 is determined to be having an issue and is rebooted, then the rules may specify that an associated modem 125 connected to the CPE networking device 120 should also be rebooted. In some cases, the rules may specify corrective measures to be performed that are likely to resolve the trouble ticket 150 based on prior history, such as that if a trouble ticket 150 presents as being similar to a historical trouble ticket 150, then the rules may determine to apply corrective measures similar to those that addressed the historical trouble ticket 150. In yet other cases, the rules may specify corrective measures that include rebooting devices from the item of equipment determined to be having an issue upstream to the connection to the network (e.g., the PTT/LEC network 110), and/or rebooting devices from the item of equipment determined to be having an issue downstream to the devices connected to the customer LAN 140.

The incident management device 145 may also be configured to update the trouble ticket associated with the customer site responsive to the attempted corrective measure. Despite these functions, at least a portion of the trouble tickets 150 may need to be worked by repair engineers of the network service provider. Exemplary trouble tickets 150 may include trouble tickets 150 automatically generated based upon loss of primary power or network connectivity of devices at the customer site.

The incident management device 145 may be further configured to facilitate the remote setup and configuration of the customer equipment via the secondary network connection 130. For example, the incident management device 145 may be configured to connect to the customer equipment via the secondary network connection 130 to provide configuration information to the customer equipment. The customer equipment may be auto-discovered by the incident management device 145 or the remote provisioning service, allowing for a registration process to be triggered. Identification of the customer equipment may be based on a hardware token or other value made available by the customer equipment. The incident management device 145 may be further configured to confirm that the customer equipment belongs to the customer network wherein it is being installed. For instance, the incident management device 145 may be configured to verify the network location of the customer equipment with information relating to which customer equipment should be installed at what sites. Moreover, for turn-up testing of a local access portion of a network once the configuration of the customer equipment is performed, one typically would need to establish a loopback on the access circuit through the PTT/LEC network 110, which may cause a temporary loss of access to the customer equipment through that connection. Despite this loss of connectivity, the incident management device 145 may maintain connectivity and remote management access with the customer equipment using the secondary network connection 130. Once the customer equipment is setup, it may then be monitored by the incident management device 145.

For ease of explanation, the trouble ticket functionality and configuration functionality are discussed herein as being handled by the incident management device 145. However, in other examples, different aspects of the functionality of the incident management device 145 may be performed by different devices and systems, for example the provisioning service. As one example, the system 100 may include separate devices or subsystems for automating issues and for automating configuration.

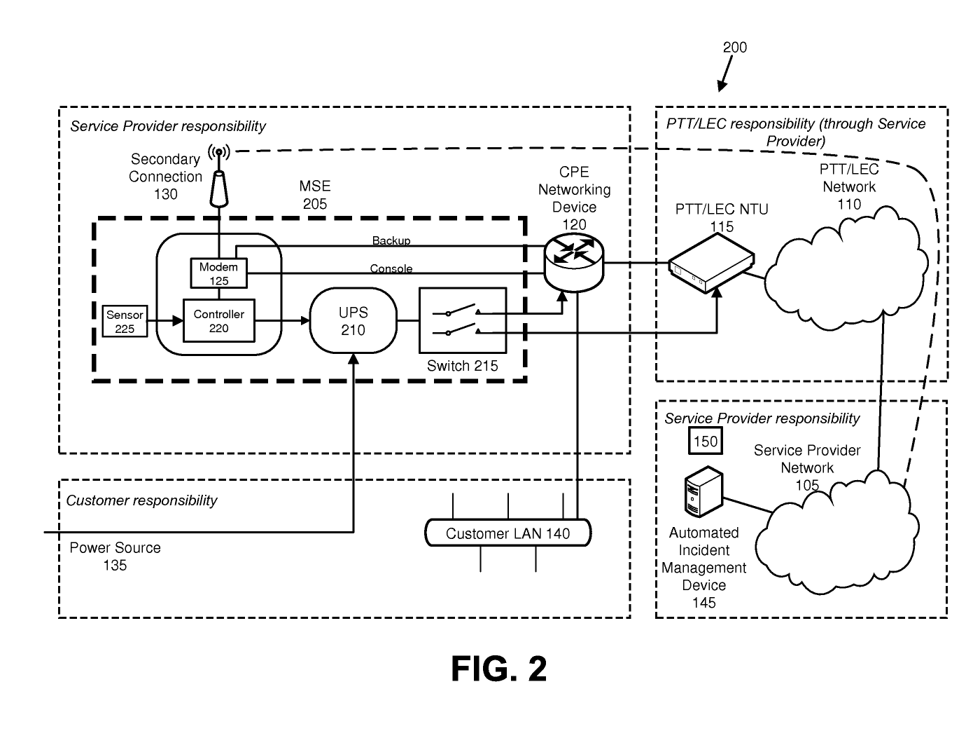

FIG. 2 illustrates an exemplary network implementation of a communications system 200 configured to provide managed services to a customer site including a managed services edge (MSE) device 205. The MSE device 205 may be included as part of an installation on a customer site of hardware configured to support a managed service, in combination with other hardware such as the CPE networking device 120 and the PTT/LEC NTU 115 discussed in detail above. More specifically, the communications system 200 may include a NSP network 105 in communication with a PTT/LEC network 110, which is in turn in communication with a PTT/LEC NTU 115.

The MSE device 205 may integrate the functionality of the modem 125 discussed above with respect to the communications system 100. For example, the integrated modem 125 of the MSE device 205 may be configured to decode communications received over the NSP network 105 as well as to encode communications for transport over the NSP network 105. The integrated modem 125 may be further configured to utilize a secondary network connection 130 to provide telemetry or configuration information, or in some cases remote access to the CPE networking device 120 when the PTT/LEC network 110 or PTT/LEC NTU 115 is unavailable. The MSE device 205 may also integrate additional functionality, such as the customer LAN 140. In such a case, the customer LAN 140 may be part of a managed service offering, where the service extends out to the LAN switches or even to the customer devices connected to the customer LAN 140. Moreover, one or more secondary network connection 130 may be implemented to remotely manage these additional customer devices.

The MSE device 205 may further incorporate a controller 220 configured to facilitate additional control and functionality in relation to the modem 125. Controller 220 may include a processor. As an example, the controller 220 may be configured to allow the MSE device 205 to provide an integrated network failover feature by way of the service provider or the secondary network connection 130. The remote failover feature may be initiated, for example, upon a loss of primary network connectivity by the MSE device 205. For instance, the failover feature may include performing a copy of configuration (and log-file) information of the CPE networking device 120 over a communication channel back to the incident management device 145, for example to provide an alternative network connection. This may be accomplished over the connection through the PTT/LEC network 110 or over a secondary network connection 130. As another possibility, the failover feature may perform a copy of customer data stored on devices of the customer LAN 140. This may be performed, for example, over the secondary network connection 130 in case the primary connection via the PTT/LEC NTU 115 and PTT/LEC network 110 has failed.

Moreover, the MSE device 205 may be configured to receive data from one or more sensors 225, such as an environmental sensor 225 configured to provide environmental information to the MSE device 205, such as temperature and humidity, as some examples.

As opposed to the communications system 100, in the system 200, the MSE device 205 may be configured to receive power from the power source 135, and to distribute the received power to other devices at the customer site. For example, the MSE device 205 may provide power to one or more of the PTT/LEC NTU 115 and the CPE networking device 120. The MSE device 205 may further include one or more switches 215 configured to selectively provide the power from the power source 135 to the other devices at the customer site according to control by the controller 220.

The MSE device 205 may further include additional functionality, such UPS 210 functionality. The UPS 210 may be configured to maintain charge from the power source 135, and also to allow the MSE device 205 to continue to provide power to the other devices at the customer site despite a loss of power from the power source 135. Equipment such as the PTT/LEC NTU 115, the CPE networking device 120, and the modem 125 may be powered by the UPS 210, while the UPS 210 may be charged by the power source 135. If the power source 135 loses power, charge stored by the UPS 210 may be sufficient to continue to power the devices for a period of time. In some examples, upon loss of power from the power source 135, the MSE device 205 may be further configured to alert the incident management device 145 of the loss of power.

The MSE device 205 may be configured to reboot, reset, or power cycle devices at the customer site. For instance, the MSE device 205 may be configured to send a message to a device to cause the device to re-initialize its software or configuration. In other cases, such as for devices that lack such reset functionality, the MSE device 205 may be configured to utilize switches 215 to allow the MSE device 205 to selectively withdraw power from devices at the customer site. Through use of reboot messages or the switches 215, the MSE device 205 may be further configured to remotely reset devices connected to the MSE device 205 (such as, for example, the PTT/LEC NTU 115 and the CPE networking device 120), without the need for any on-site customer interaction.

In addition to putting the equipment into a known state, an additional aspect of performing a reboot/power cycle of the PTT/LEC NTU 115 is that it may aid in confirming if the cabling between the PTT/LEC NTU 115 and the CPE networking device 120 is in place and working. For instance, there may be a signaling protocol utilized between the PTT/LEC NTU 115 and the CPE networking device 120, for example, Ethernet settings may be negotiated between the devices. Upon reboot of the PTT/LEC NTU 115, the PTT/LEC NTU 115 may then start to renegotiate the protocol and may send alarm or status indications to the CPE networking device 120 to indicate that the connection protocol is up or down. If this type of information is not received by the CPE networking device 120 after rebooting the PTT/LEC NTU 115, then this could indicate that the cabling between the PTT/LEC NTU 115 and CPE networking device 120 may be faulty or incorrectly connected. This type of information may accordingly allow the incident management device 145 to use predefined rules to assess the incident and take corrective measures likely to resolve the incident.

Accordingly, the MSE device 205 may be configured to reduce the need for customer interaction and to allow for time to notify the customer and the managed services provider that local on-site power has been lost due to the additional capacity of the UPS 210. Moreover, the incident management device 145 may be configured to avoid assigning resources to incidents caused by local power interruptions, which may be the customer's responsibility.

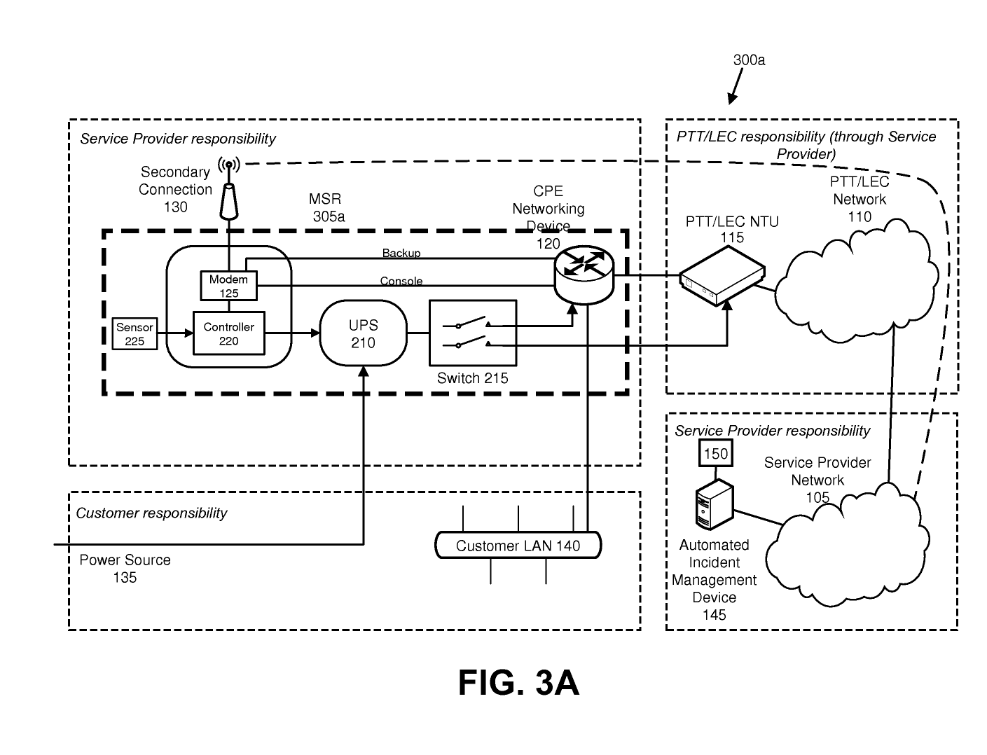

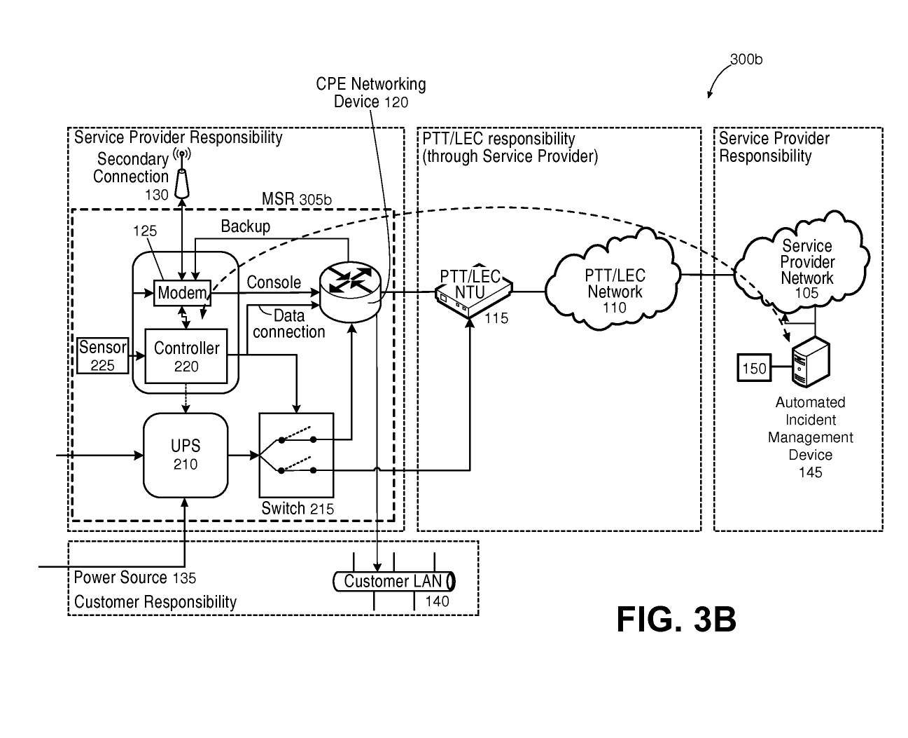

FIG. 3A illustrates an exemplary network implementation of a communications system 300a configured to provide managed services to a customer site including a managed services router (MSR) device 305. The MSR device 305a may integrate the functionality of the MSE device 205 and the CPE networking device 120 discussed above with respect to the communications systems 100 and 200. As compared to having separate MSE device 205 and CPE networking devices 120, the MSR device 305a may integrate the CPE networking device 120 and therefore reduce a number of external physical interfaces, which may have a positive result on the overall system availability by reducing the number of cables and connectors that may fail.

In some examples, the MSR device 305a may be implemented using low-power computer components, such as laptop CPU and battery components. Use of such components may reduce engineering efforts as laptop components are designed to operate on battery (DC) power. Use of such components may also offer flexibility, as portable motherboards may offer variety in input/output connections or networking interfaces.

Moreover, by inclusion of the CPE networking device 120 into the MSR device 305a, the UPS 210 functionality may be simplified and optimized. For example, the CPE networking device 120 may operate at a DC voltage in the range of 3-20 volts, where in order to power the CPE networking device 120 from AC, a power supply is required to convert the power source 135 into a low voltage DC. For an integrated router function in the MSR device 305a, a direct switched DC feed from the UPS 210 may be used to avoid relatively lossy power conversions, such as a DC-AC conversion from the UPS 210 battery to supply power to the CPE networking device 120 followed by an AC-DC power conversion by the CPE networking device 120.

Further, in case of the AC input failing, the MSR device 305a may be configured to switch to a power save mode, in which power intensive processes may be disabled or otherwise adjusted to increase UPS 210 battery life. For example, the power save mode may be configured to maintain power to support the secondary network connection 130 until UPS 210 depletion, to ensure a maximum duration of remote management, control, and remote backup.

In some cases, the battery of the UPS 210 may be accessible and user-replaceable, for example, similar to how a laptop battery may be removable. Because battery lifetime may be limited, ease of access and ease of replacement of the UPS 210 battery by on-site staff or network service provider field engineers may be a further advantage of the MSR device 305a design.

FIG. 3B illustrates an exemplary network implementation of a communications system 300b configured to provide managed services to a customer site including a managed services router (MSR) device 305b having a controller 220 configured to execute self-healing operations. Controller 220 may be communicatively and operatively connected to incident management device 145. Similar to MSR device 305a, MSR device 305b may integrate the CPE networking device 120, for example, as an alternative to separate MSE device 205 and CPE networking device 120.

The system (e.g., controller 220 or incident management system 145) may be configured to act as a watchdog with respect to customer equipment. For example, controller 220 may be configured to operate without connectivity to incident management system 145. Furthermore, the system may be configured as an automated device manager, for example, as shown in exemplary processes 850 and 1000 below. Moreover, the system may be configured to execute fault tree analysis, for example, as shown in exemplary process 900 below. In addition, the system may be configured to detect fault conditions, measure failure symptoms, execute corrective measures, and report root causes, for example, as provided in exemplary table 1 below.

Similar to MSR device 305a, MSR device 305b may be configured to automatically detect AC power from power source 135, utilize DC backup power from UPS 210 under AC power failure conditions, automatic and remote reboot of the CPE networking device 120 and PTT/LEC NTU 115 to recover from certain fault conditions, and utilize secondary connection 130 in the event of failure of the primary connection.

MSR device 305b may further include controller 220 configured to monitor and execute periodic or continuous measurements thereby acting as a watchdog with respect to the system. Controller 220 may be configured to monitor and measure the external environment (e.g. power, temperature, and radio signal coverage) as well as the internal environment (e.g., availability and performance of the managed services). Controller 220 may further be configured to monitor data flowing throughout the system, for example, to measure failure symptoms. For example, controller 220 may monitor and measure data packets flowing on and configuration register values of CPE networking device 120. Alternatively, controller 220 may be configured to monitor and measure data with respect to any other portion of the system.

Controller 220 may be configured to operate as a stand-alone controller to restore service to customer premises equipment. For instance, controller 220 may no longer be connected to service provider network 105 (e.g. both primary and secondary connections may not be available). The controller 220 may still execute the self-healing actions. If the primary network connection goes down, the controller 220 may be disconnected from the service provider network 105, but may still execute the self-healing rules to restore service. Thus, controller 220 may be configured to restore service without connectivity to automated incident management device 145 or service provider network 105.

More specifically, MSR device 305b may be configured to execute self-healing operations in response to system issues. For example, self-healing rules may be executed in response to any number of fault conditions, examples provided in process 900 and table 1 below, and adjusted according to service management information, as provided in processes 850 and 1000 below. An incident management device 145 may include memory and a central processor, for example, configured to receive service management information from one or more controllers 220. Each controller 220 may be associated with a customer site and may include memory and a controller processor, for example, configured to execute self-healing rules. The self-healing rules may include one or more corrective measures associated with one or more failure symptoms.

The system (e.g., at least one of controller 220 and incident management device 145) may be configured to generate a correlation between at least one corrective measure with at least one failure symptom, adjust the self-healing rules based on the correlation, and propagate the adjusted self-healing rules to one or a plurality of controllers 220 at one or a plurality of customer sites. Thus, the self-healing rules may evolve based on the collective learning of the plurality of controllers 220 at a plurality of customer sites, examples provided in processes 850 and 1000 below.

MSR device 305b may be configured to execute self-healing with respect to any portion of system, for example PTT/LEC NTU 115 or CPE networking device 120. To execute self-healing, the processor of controller 220 may include an embedded processor configured to respond to fault conditions with respect to any other processor of the system. Controller 220 may be configured to execute operations, for example, based on process 900 and table 1 below.

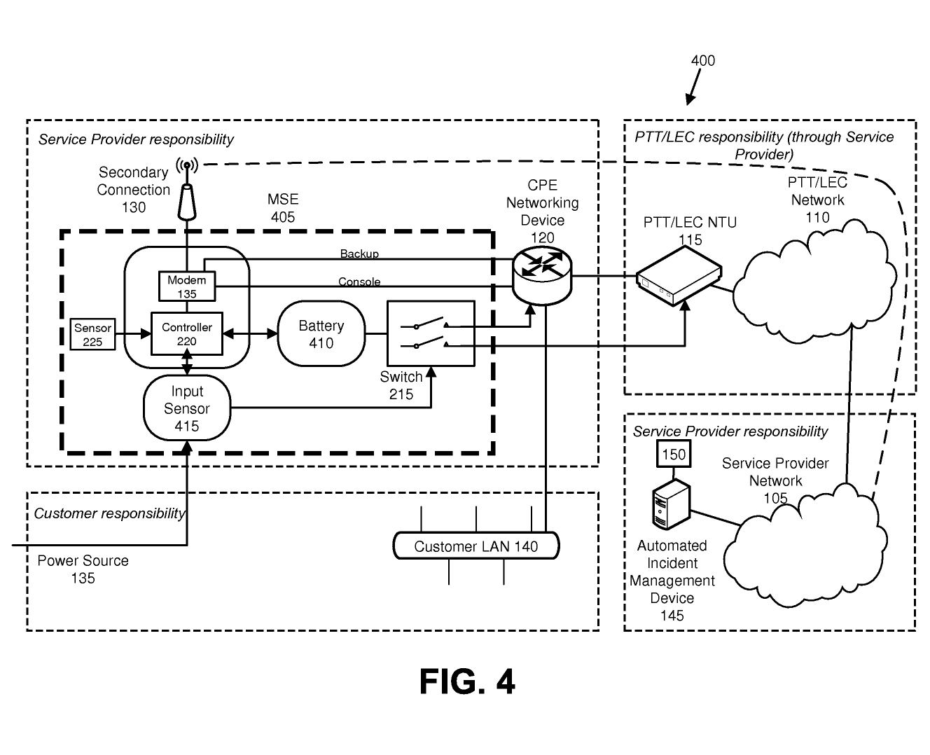

FIG. 4 illustrates an exemplary network implementation of a communications system 400 configured to provide managed services to a customer site including an alternate MSE device 405. Similar to the MSR device 205, The MSE device 405 may integrate functionality such as the modem 125, controller 220, and switch 215 as discussed above with respect to the communications systems 100 and 200.

The MSE device 405 may be configured to notify the incident management device 145 of issues with the power source 135. For example, the controller 220 may be configured to monitor the power source 135 and notify the incident management device 145 in case the power source 135 becomes unavailable. This function may be achieved by utilizing a battery 410 configured to provide power to the modem 125 and controller 220, instead of or in addition to the UPS 210. While not illustrated, the battery 410 functionality may similarly be implemented into an MSR, such as the MSR device 305a and 305b discussed above with respect to communication system 300a and 300b.

The MSE device 405 may further be configured to notify the incident management device 145 of network connectivity issues. For example, the controller 220 may be configured to monitor the connection to the service provider via the CPE networking device 120, and if a network outage is detected, the controller 220 may be configured to provide a notification to the incident management device 145 by way of a secondary network connection 130. The incident management device 145 system may also be configured to monitor the CPE networking device 120 in parallel, and generate a router down message if CPE networking device 120 becomes unreachable.

In some examples, either a message generated by the MSE device 405 or a message generated by the incident management device 145 may be sufficient to cause the incident management device 145 to trigger certain actions. In other examples, the incident management device 145 may wait to receive a message from the MSE device 405 and also correlate the message with an identified issue determined according to the remote monitoring of the customer site. For instance, upon both the MSE device 405 and the incident management device 145 identifying a CPE networking device 120 issue with a power source 135, the incident management device 145 may move a trouble ticket 150 associated with the customer site to a status indicative of the issue being one for the customer to address. Or, upon both the MSE device 405 and the incident management device 145 identifying a loss of connectivity with no corresponding loss of power, the incident management device 145 may move the trouble ticket 150 to a working state and may assign a network engineer to work on the trouble ticket 150.

Moreover, the MSE device 405 may be configured to reset or reboot one or more of the CPE networking device 120 or PTT/LEC NTU 115 upon receiving a remote reboot command, such as from the incident management device 145. The reboot may be performed by the MSE device 405 withdrawing power from the CPE networking device 120 or PTT/LEC NTU 115 by the controller 220 using the switches 215 to disconnect and reconnect the power source 135 to the CPE networking device 120 or PTT/LEC NTU 115.

It should be noted that the MSE device 205, MSR devices 305a and 305b, and MSE device 405 are only exemplary devices, and variations on the MSE and MSR devices are possible. As an example, the MSE device 205, MSR device 305a or 305b, or MSE device 405 may be further modified to include WLAN controller functionality to further reduce the customer responsibility. This additional inclusion may also again reduce a number of cables and subsystems (e.g., a separate WLAN controller as separate device). As another example, the MSE device 205, MSR device 305a or 305b, or MSE device 405 may be further modified to include a WLAN controller and also a LAN switch, making a combined unit where a customer may have direct LAN access (wired or wireless) to the managed device.

In general, computing systems and/or devices, such as the MSE device 205, MSR device 305a or 305b, MSE device 405, CPE networking device 120 or PTT/LEC NTU 115 may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance.

Computing devices may generally include computer-executable instructions that may be executable by one or more processors. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor or microprocessor receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computing device). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, such as the storage of trouble tickets 150, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. For example, aspects of the operations performed by the incident management device 145 may be implemented by an application software program executable by an incident management device 145. In some example, the application software product may be provided as software that when executed by a processor of the incident management device 145 provides the operations described herein. Alternatively, the application software product may be provided as hardware or firmware, or combinations of software, hardware and/or firmware.

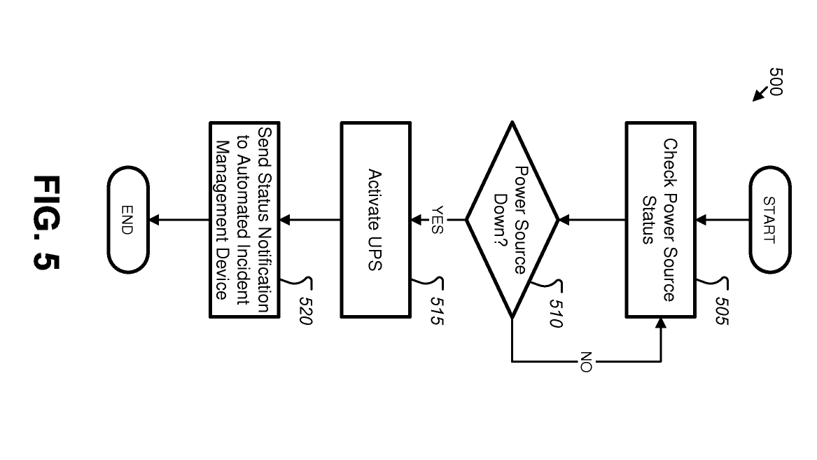

FIG. 5 illustrates an exemplary process 500 for customer equipment configured to monitor managed services at a customer site. The process 500 may be performed by various devices, such as by a MSE device 205, MSR device 305a or 305b, or MSE device 405 in communication with an incident management device 145.

In block 505, the customer equipment checks the status of the power source 135. For example, the customer equipment may be connected to the power source 135, and may determine whether the power source 135 is presently providing power.

In decision point 510, the customer equipment determines whether the power source 135 is down. For example, if the customer equipment determines that the power source 135 is of a lower or higher voltage than specified, or is not providing power at all, then the customer equipment may determine that the power source 135 is down. If the power source 135 is up, control passes to block 505. If the power source 135 is down, control passes to block 515.

In block 515, the UPS 210 becomes activated to power the customer equipment. For example, the UPS 210 may continue to provide power to the other devices at the customer site despite a loss of power from the power source 135.

In block 520, the customer equipment sends a status notification to an incident management device 145. For example, if the primary network connection is still usable, and if power may still be supplied to the customer equipment (e.g., via a UPS 210), the customer equipment may send a message to the incident management device 145 by way of a PTT/LEC NTU 115, PTT/LEC network 110, and NSP network 105. As another example, the customer equipment may send the message to the incident management device 145 by way of a secondary network connection 130, such as over a PTSN link or wirelessly over a cellular data network. After block 520, the process 500 ends.

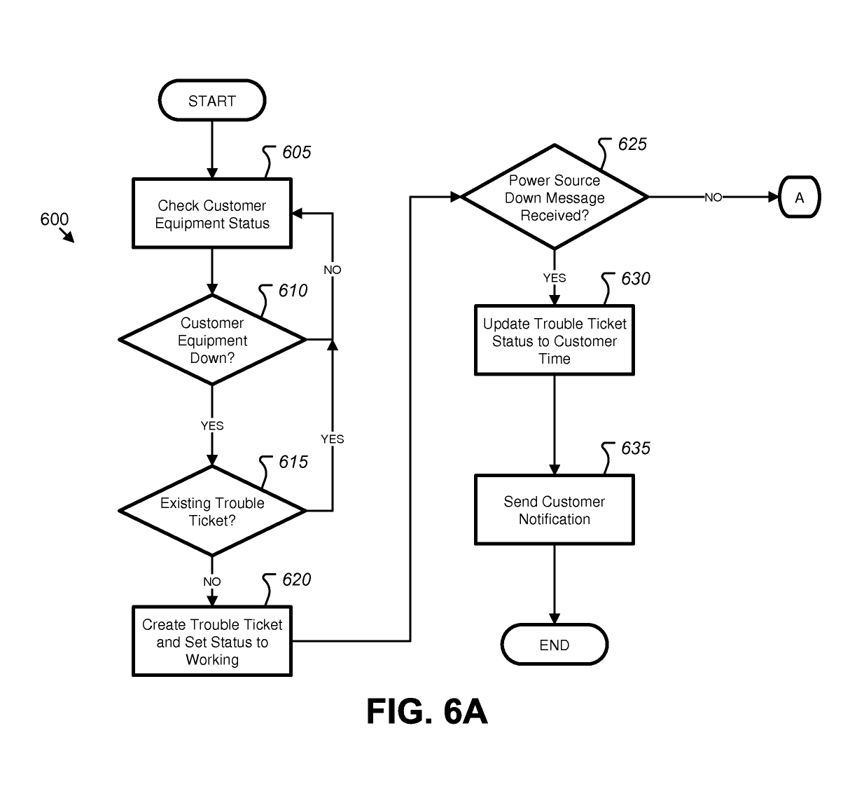

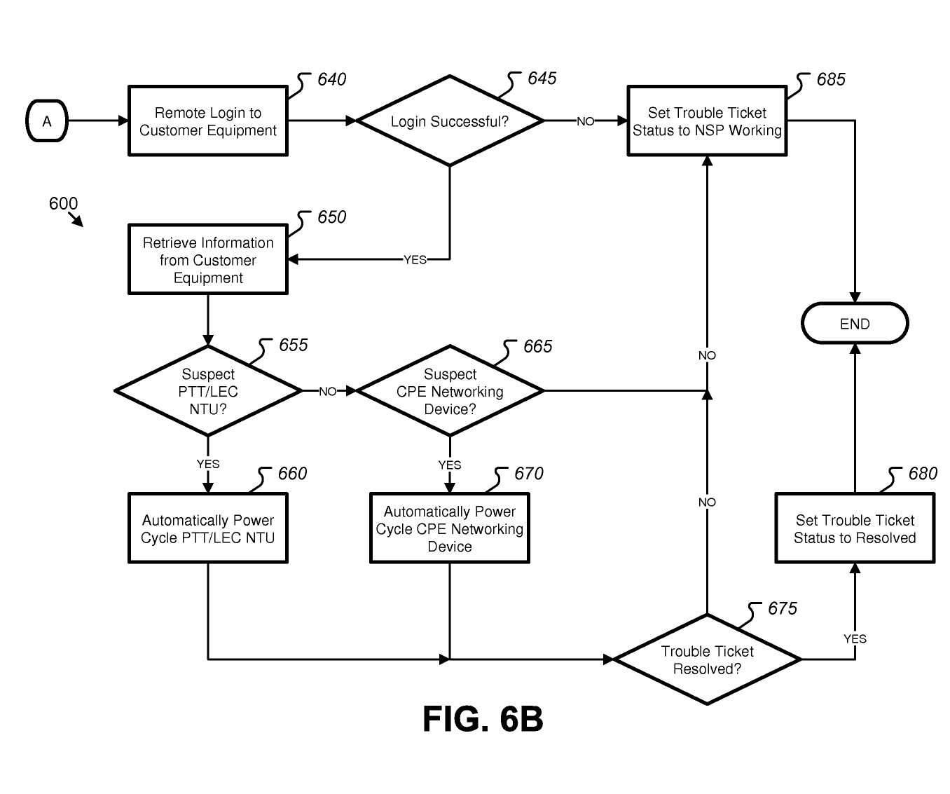

FIGS. 6A and 6B illustrate an exemplary process 600 for an incident management device 145, for example, configured to remotely monitor and manage services at customer sites. The process 600 may be performed by an incident management device 145 configured to manage a plurality of customer sites and associated customer equipment devices. The customer equipment devices may include one or more of a MSE device 205, a MSR device 305a or 305b, a MSE device 405, a CPE networking device 120, or a PTT/LEC NTU 115 at a customer site in communication with an incident management device 145.

In block 605, the incident management device 145 checks the status of customer equipment at a customer site. For example, the incident management device 145 may periodically send a status request message to each CPE networking device 120 or other item of customer equipment being monitored by the incident management device 145. In some examples, the status request message may be a ping message, while in other cases the status request message may take the form of a request for information, such as a request for aspects of the usage or configuration of the customer equipment.

In decision point 610, the incident management device 145 determines whether the customer equipment is down (e.g., non-operational). For example, if the CPE networking device 120 or other item of customer equipment fails to respond to a status request or is unavailable for a duration of time, the incident management device 145 may determine that the CPE networking device 120 is down. In some cases, the CPE networking device 120 may fail to respond because the CPE networking device 120 has locked up or lost power. If the customer equipment is down, control passes to decision point 615. Otherwise, control passes to block 605.

In decision point 615, the incident management device 145 determines whether an existing trouble ticket 150 exists for the customer equipment. For example, the incident management device 145 may query a data store of trouble ticket 150 for an identifier of the CPE networking device 120 or other item of customer equipment that is determined to be down. If an existing trouble ticket 150 exists for the customer equipment, control passes to decision point 655. Otherwise, control passes to block 605.

In block 620, the incident management device 145 creates a trouble ticket 150 for the customer equipment being down. For example, the incident management device 145 may send a command to the data store of trouble ticket 150 configured to cause the data store to create a new trouble ticket 150 associated with the identifier of the customer equipment determined to be down.

In decision point 625, the incident management device 145 determines whether a power down message associated with the customer equipment has been received from the customer equipment. For example, the incident management device 145 may query a data source to determine whether the incident management device 145 received a power source 135 down message from a device at the same customer site as the customer equipment. The message may include an identifier of the CPE networking device 120 or of another device at the customer site having an issue. In other cases, the message may include an identifier of the user, or of the managed services account. If a power down message associated with the customer equipment was received, control passes to block 630. Otherwise, control passes to block 640 as described in detail with respect to FIG. 6B.

In block 630, the incident management device 145 updates the identified trouble ticket 150 associated with the customer equipment to indicate the existence of an issue that is the responsibility of the customer. For example, the incident management device 145 may send an update to the data store configured to indicate that the power source 135 down message received from the customer device has been correlated with a corresponding customer equipment down determination made by the incident management device 145.

In block 635, the incident management device 145 sends a notification to the customer of the issue indicating that the issue is the responsibility of the customer, not of the provider of the managed service. After block 635, the process 600 ends.

In block 640 of FIG. 6B, the incident management device 145 logs into the customer equipment. For example, the incident management device 145 may log into a MSE device 205, a MSR device 305a or 305b, or a MSE device 405 at the customer site. In some cases, the login to the customer site may be performed according to a secondary network connection 130 to the customer site, such as by way of a wireless network or a connection to the PSTN over a telephone line.

In decision point 645, the incident management device 145 determines whether the login was successful. For example, the login may be successful if the customer equipment could be connected to over the secondary network connection 130. However, in some cases the customer equipment may be inaccessible via the secondary network connection 130, or may be damaged or otherwise inaccessible. In such cases the login would not succeed. If the login was successful, control passes to block 650. Otherwise, control passes to block 685.

In block 650, the incident management device 145 retrieves information from the customer equipment. For example the incident management device 145 may be configured to retrieve log files or configuration information from the CPE networking device 120 or other items of customer equipment, such as a MSE device 205, a MSR device 305a or 305b, or a MSE device 405 at the customer site. Advantageously, the incident management device 145 may retrieve the information before a user attempts to address the issue by rebooting the customer equipment, as rebooting may delete evidence of the underlying cause of the trouble ticket 150.

In decision point 655, the incident management device 145 determines whether the PTT/LEC NTU 115 is likely a cause of the trouble ticket 150. For example, the incident management device 145 may determine according to rules that specify corrective measures likely to resolve the trouble ticket 150 that, based on the retrieved information from the customer equipment, the incident management device 145 may determine that the PTT/LEC NTU 115 has experienced an error and may require a reboot. For instance, polling of the customer equipment or log file information retrieved from devices at the customer site may indicate that the PTT/LEC NTU 115 is no longer functioning. If the information indicates that the issue may be with the PTT/LEC NTU 115, control passes to block 660. Otherwise, control passes to decision point 665.

In block 660, the incident management device 145 initiates a remote power cycle of the PTT/LEC NTU 115. For example, the incident management device 145 may send a reboot message to a MSE device 405 at the customer site by way of the login to the customer equipment discussed above. The MSE device 405 may in turn be configured to reboot the PTT/LEC NTU 115 using a switch 215.

In decision point 665, the incident management device 145 determines whether the CPE networking device 120 is likely a cause of the trouble ticket 150. For example, the incident management device 145 may determine according to rules that specify corrective measures likely to resolve the trouble ticket 150 that, based on the retrieved information from the customer equipment, the incident management device 145 may determine that the CPE networking device 120 has experienced an error and may require a reboot. For instance, polling of the customer equipment or log file information retrieved from devices at the customer site may indicate that the CPE networking device 120 is no longer functioning. If the information indicates that the issue may be with the CPE networking device 120, control passes to block 670. Otherwise, control passes to decision point 685.

In block 670, the incident management device 145 initiates a remote power cycle of the CPE networking device 120. For example, the incident management device 145 may send a reboot message to a MSE device 405 at the customer site by way of the login to the customer equipment discussed above. The MSE device 405 may in turn be configured to reboot the CPE networking device 120 using a switch 215.

In decision point 675, the incident management device 145 determines whether the trouble ticket 150 has been resolved. For example, the incident management device 145 may attempt to communicate with the customer equipment, such as using the PTT/LEC NTU 115 and CPE networking device 120. If communication is established with the customer equipment, then the incident management device 145 may determine that the trouble ticket 150 has been resolved. If so, control passes to block 680. Otherwise, control passes to block 685.

In block 680, the incident management device 145 associates the trouble ticket 150 with a resolved status. After block 680, the process 600 ends.

In block 685, the incident management device 145 associates the trouble ticket 150 with a network service provider working status. Accordingly, because the issue indicated by the trouble ticket 150 persists, and further because the issue has been determined not to obviously be the fault of the customer, network service provider personnel may be assigned to further diagnose and address the trouble ticket 150. After block 685, the process 600 ends.

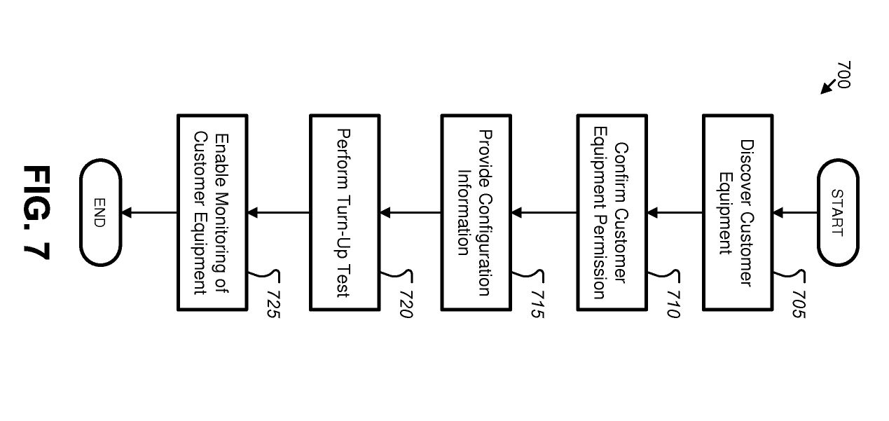

FIG. 7 illustrates an exemplary process 700 for an incident management device 145 configured to set up customer equipment. As with the process 600, the process 700 may be performed by an incident management device 145 configured to manage a plurality of customer sites and associated customer equipment devices. The customer equipment devices may include one or more of a MSE device 205, a MSR device 305a or 305b, a MSE device 405, a CPE networking device 120, and a PTT/LEC NTU 115 at a customer site in communication with an incident management device 145.

In block 705, the incident management device 145 discovers the customer equipment. For example, the incident management device 145 may listen for requests from customer equipment sent to an address of the incident management device 145, or the incident management device 145 may periodically scan the network addresses of customer sites for the addition of devices that may respond to the scan requests.

In block 710, the incident management device 145 confirms permissions of the customer equipment. For example, the automated incident management device may retrieve an identifier or hardware token value from the discovered customer equipment, and may verify the network location of the customer equipment with information relating to which customer equipment should be installed at what customer sites.

In block 715, the incident management device 145 provides configuration information to the customer equipment. For example, the incident management device 145 may provide settings or other network parameters to the customer equipment. This information may be sent by way of the secondary network connection 130 for cases where the customer equipment may not be configured to receive such transmissions without being configured. For security reasons, in some examples configuration information may be alterable via the secondary network connection 130 but not by way of a primary network connection.

In block 720, the incident management device 145 performs turn-up testing of the customer equipment. For example, the incident management device 145 may initiate testing of a local access portion of a network once the configuration of the customer equipment is performed by establishing a loopback on the access circuit through the PTT/LEC network 110, which may cause a temporary loss of access to the customer equipment through the primary connection.

In block 725, the incident management device 145 enables monitoring of the customer equipment. Monitoring of the customer equipment may be performed, for example, using processes such as the processes 500 and 600 discussed in detail above.

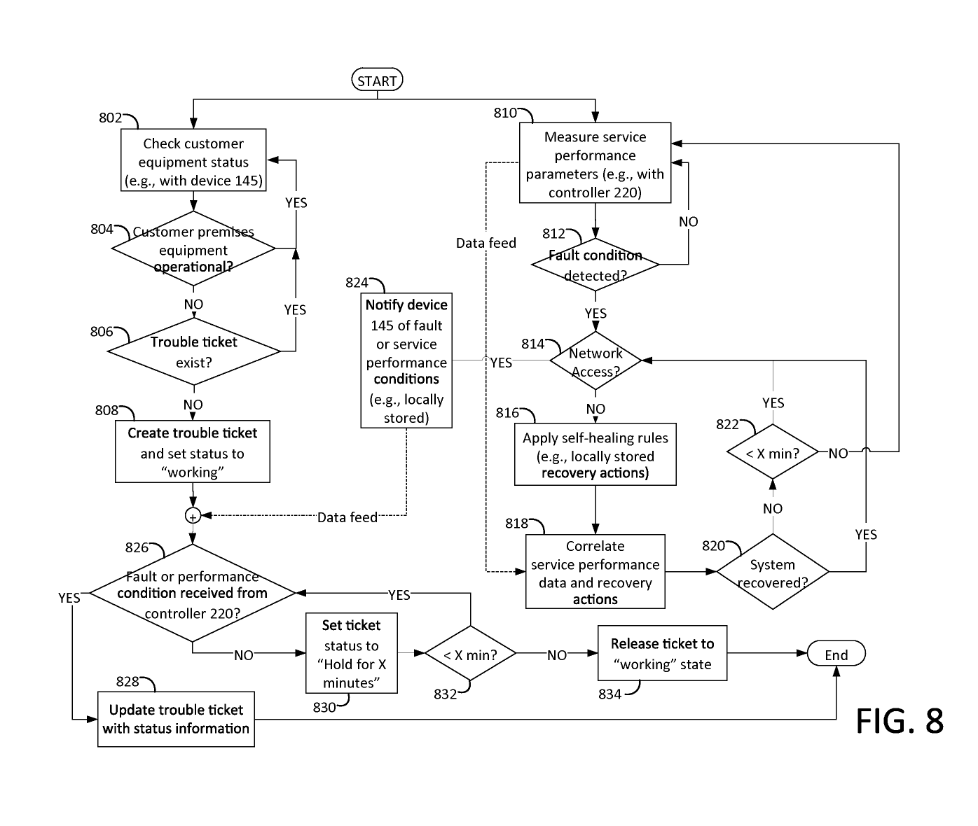

FIG. 8 illustrates an exemplary process 800 for an incident management device 145, for example, in response to loss of primary power or network connectivity. As with the process 700, the process 800 may be performed by an incident management device 145 configured to manage a plurality of customer sites and associated customer equipment devices. The customer equipment devices may include one or more of a MSE device 205, a MSR device 305a or 305b, a MSE device 405, a CPE networking device 120, and a PTT/LEC NTU 115 at a customer site in communication with an incident management device 145.

In block 802, automated incident management device 145 may be configured to check a status of customer premises equipment of a customer site, as described above.

At decision point 804, the incident management device 145 may check if the customer premises equipment is operational. For example, the incident management device 145 may attempt to remotely access modem 125, for example, using the console port to access CPE networking device 120. Further, the incident management device 145 may confirm that the system (e.g., PTT/LEC NTU 115, CPE networking device 120, and modem 125) is powered up and properly connected. The incident management device 145 may also power-cycle the system or a check for cable faults. In addition, the incident management device 145 may check the network connectivity of PTT/LEC NTU 115, whether PTT/LEC NTU 115 has been rebooted, and the LED status of PTT/LEC NTU 115. The incident management device 145 may also inspect the log information of the CPE networking device 120 for root causes. If the customer premises equipment is operational, automated incident management device 145 may re-perform block 802. If the customer premises equipment is not operational, incident management device 145 may confirm if a trouble ticket exists.

At decision point 806, the incident management device 145 may check if a trouble ticket exists, as described above. If a trouble ticket exists, the incident management device 145 may re-perform block 802 or the process may end. If a trouble ticket does not exist, incident management device 145 may create a trouble ticket.

At block 808, the incident management device 145 may create a trouble ticket and set the status of the incident ticket to “working” indicating that the trouble ticket is pending and more repair activities may be required to resolve the system issue.

At block 810, the controller 220 may measure service performance information, as described herein.

At decision point 812, the controller 220 may determine if a fault condition is detected. If a fault condition is detected, the controller 220 may check connectivity to service provider network 105.

At decision point 814, the controller 220 may check access to service provider network 105. If there is no access, the controller 220 may apply self-healing rules. If there is access, the controller 220 may notify device 145 of a fault or service performance condition, which may be stored as part of controller 220.

At block 816, the controller 220 may apply self-healing rules including recovery actions, which may be stored as part of controller 220.

At block 818, the controller 220 may correlate the service performance information and the recovery actions.

At decision point 820, the controller 220 may check to determine if the system is recovered, for example, by checking connectivity with respect to service provider network 105.

At decision point 822, the controller 220 may check connectivity with respect to service provider network 105. If connectivity is established within a predetermined period of time, the controller 220 may re-perform block 814. If connectivity is not established with a predetermined period of time, the controller 220 may re-perform block 810.

At block 824, the controller 220 may notify the incident managed device 145 of the fault or service performance conditions, for example, using a data feed connected to the incident management device 145.

At decision point 826, the incident management device 145 may determine if a fault or performance condition is received from controller 220. If a fault or performance condition is received, the incident management device 145 may update the trouble ticket with status information. If a fault or performance condition is not received, the incident management device 145 may hold the incident ticket for a predetermined amount of time.

At block 828, the incident management device 145 may update the trouble ticket with status information.

At block 830, the incident management device 145 may set a ticket status with an indication to hold the incident ticket for the predetermined amount of time.

At decision point 832, the incident management device 145 may check to determine if the predetermined amount of time has been reached. If the predetermined amount of time has not been reached, the incident management device 145 may re-perform decision point 826. If the predetermined amount of time has been reached, the incident management device 145 may release the incident ticket.

At block 834, the incident management device 145 may release the incident ticket to indicate the system is working or that service has been restored. After block 834, the process may end.

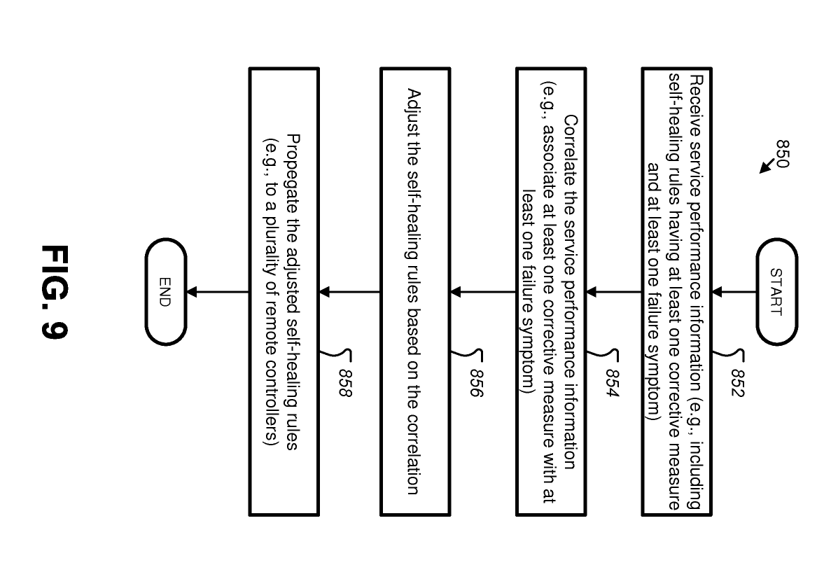

FIG. 9 illustrates an exemplary process 850 for adjusting self-healing rules, for example, based on service management information. Process 850 may be performed by controller 220 or an incident management device 145 configured to manage a plurality of customer sites and associated customer equipment devices, which may be remote from incident management device 145. The customer equipment devices may include one or more of a MSE device 205, a MSR device 305a or 305b, a MSE device 405, a CPE networking device 120, and a PTT/LEC NTU 115 at a customer site in communication with an incident management device 145.

At block 852, the system (e.g., at least one of controller 220 or incident management device 145) may receive or collect service management information, as defined above.

At block 854, the system (e.g., at least one of controller 220 and incident management device 145) may correlate the service management information, for example, by associating at least one corrective measure with at least one failure symptom.

At block 856, the system may adjust the self-healing rules based on the correlation.

At block 858, the system may be configured to propagate the adjusted self-healing rules, for example, to a plurality of remote controllers. After block 858, process 850 may end or restart at block 852 with respect to the plurality of remote controllers.

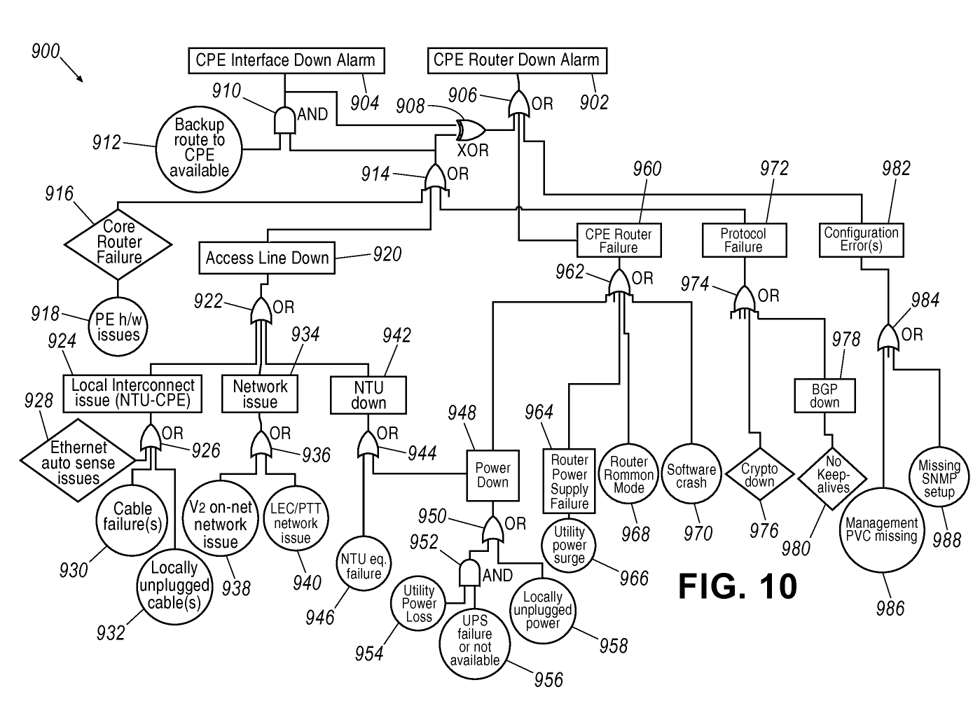

FIG. 10 illustrates an exemplary process 900 for a fault tree analysis (FTA) as part of a set of self-healing rules, for example, which may be generated by incident management device 145 or controller 220. Process 900 may be performed by controller 220 or an incident management device 145. The customer equipment devices may include one or more of a MSE device 205, a MSR device 305a or 305b, a MSE device 405, a CPE networking device 120, and a PTT/LEC NTU 115 at a customer site in communication with an incident management device 145.

The fault tree analysis may be generated to determine the underling failures associated with system issues, for example, based on in part on a historic learning of failures and human inputs such as engineering best practices. The fault tree analysis may be used to generate or update self-healing rules, for example, to correct system issues or to restore service.

Exemplary process 900 shows a fault tree analysis having fault conditions connected to logic gates defining a number of branches with associated failure symptoms of the system. Top level fault conditions may include CPE Router down alarm 902 and CPE interface alarm 904, which may be generated by controller 220 or incident management device 145. CPE interface alarm 904 may generally indicate a first fault condition associated with managed services (e.g., PTT/LEC NTU 115) and CPE router down alarm 902 may indicate a second fault condition associated with managed services (e.g., CPE networking device 120). Each failure symptom may be given a symptom failure probability relative with respect to total system failure. To restore service, controller 220 or incident management device 145 may generate the self-healing rules to detect fault conditions, measure symptoms, execute corrective measures, and identify root causes. In addition, controller 220 or incident management device 145 may be configured to analyze service management information to continually refine the failure analysis of recurring fault conditions or failure symptoms.

Exemplary process 900 may include logic gates associated with each top level alarm that are associated with one or more failure symptoms. Each logic gate may define whether each of the underlying symptoms are detected (e.g., generating a “True” or “1”) or not detected (e.g., generating a “False” or “0”). Depending on the type of logic gate, each logic gate associates underlying failure symptoms with the logic gate or top level alarm from which the logic gate depends. Exemplary logic gates may include an OR gate, AND gate, XOR gate, or any other type of logic gate suitable for failure analysis. Each OR gate may associate underlying failure symptoms based on whether any of the underlying failure symptoms are detected. Each AND gate may associate underlying failure symptoms if all of the underlying failure symptoms are detected. Each XOR gate may associate underlying failure symptoms if either all or none of the underlying failure symptoms are detected. Process 900 may be generated by the system (e.g., incident management device 145 or controller 220) to associate top level alarms with any number of underlying failure symptoms.

At block 902, CPE router down alarm 902 may be detected.

At block 904, CPE interface down alarm 904 may be detected.

At block 906, OR gate 906 may associate any of the depending failure symptoms with block 902.

At block 908, XOR gate 908 may associate depending failure symptoms if both or neither of block 910 and block 914 have associated failure symptoms.

At block 910, AND gate 910 may associate depending failure symptoms if block 912 and block 914 having depending failure symptoms.

At block 912, an availability check of a backup route to CPE networking device 120 may be performed.

At block 914, OR gate 914 may associate any of the depending failure symptoms with block 908.

At block 916, a core failure check of CPE networking device 120 may be performed.

At block 918, a hardware issue check of CPE networking device 120 may be performed.

At block 920, an access line check may be performed.

At block 922, OR gate 922 may associate any of the depending failure symptoms from any of blocks 924, 934, and 942.

At block 924, a interconnect check may be performed with respect to PTT/LEC NTU 115 and CPE networking device 120.

At block 926, OR gate 926 may associate any of the depending failure symptoms from any of blocks 928, 930, and 932.

At block 928, an Ethernet check may be performed, for example, by automatically sensing for issues with respect to PTT/LEC NTU 115 or CPE networking device 120.

At block 930, a cable failure check may be performed with respect to PTT/LEC NTU 115 and CPE networking device 120.

At block 932, a cable check may be performed, for example, to check for unplugged cables with respect to PTT/LEC NTU 115 or CPE networking device 120.

At block 934, a network issue check may be performed.

At block 936, OR gate 936 may associate any of the depending failure symptoms from any of blocks 938 and 940.

At block 938, a connectivity check may be performed with respect to service provider network 105.

At block 940, a connectivity check may be performed with respect to PTT/LEC network 110.

At block 942, an NTU check may be performed, for example, to determine if PTT/LEC NTU 115 may be down.

At block 944, OR gate 994 may associate any of the depending failure symptoms from any of blocks 946 and 948.

At block 946, an equipment failure check may be performed with respect to PTT/LEC NTU 115.

At block 948, a power check may be performed, for example, to determine if the power is down.

At block 950, OR gate 950 may associate any of the depending failure symptoms from any of blocks 952 and 958.

At block 952, AND gate 952 may associate depending failure symptoms if block 954 and 956 are detected.

At block 954, a utility power check may be performed to determine if power from an associated utility company has been lost.

At block 956, a UPS power check may be performed to detect a failure or unavailability of UPS 210.

At block 958, at local power check may be performed to determine if the power to the customer premises equipment has been unplugged.

At block 960, a CPE router check is performed with respect to CPE networking device 120, for example, to detect a router failure.

At block 962, OR gate 960 may associate any of the depending failure symptoms form any of blocks 948, 964, 968, and 970.

At block 964, a power supply check is performed to detect a power supply failure with respect to CPE networking device 120.

At block 966, a power surge check is performed to detect, for example, a power surge from an associated utility company.

At block 968, a mode check is performed, for example, to detect if CPE networking device 120 is in a ROM monitor mode, also referred to as ROMmon mode. The ROM monitor is a program of CPE networking device 120 that initializes the hardware and software of CPE networking device 120 in response to powering or loading CPE networking device 120. If the mode check determines that CPE network device 120 is in a ROM monitor mode, this is an indication of a boot or configuration issue with CPE networking device 120.

At block 970, a software check is performed to detect a software crash, for example, with respect to controller 220 or incident management device 145.

At block 972, a protocol check is performed to detect protocol failures.

At block 974, OR gate 974 may associate any of the depending failure symptoms from any of blocks 976 and 978.

At block 976, a first protocol check may be performed to determine if a crypto program of CPE networking device 120 is down.

At block 978, a second protocol check may be performed to determine if the border gateway protocol (BGP) of CPE networking device 120 is down.

At block 980, to perform the second protocol check, a keep-alives check may be performed to determine connectively with respect to PTT/LEC NTU 115. The keep-alive check may include sending a test data packet (“keep-alive”) to PTT/LEC NTU 115. If the keep-alive is returned by CPE networking device 120, PTT/LEC NTU 115 has connectivity. If the keep-alive is not returned or is delayed, PTT/LEC NTU 115 may have lost or limited connectivity.

At block 982, a configuration check may be performed to detect configuration errors.

At block 984, OR gate 984 may associate any depending failure symptoms from any of blocks 986 and 988.

At block 986, a first configuration check may be performed to detect any virtual connection issues, for example, a missing virtual connection permanent virtual circuit (PVC).

At block 988, a second configuration check may be performed to detect any Internet protocol issues, for example, a setup issue with a simple network management protocol (SNMP). After block 988, the fault conditions are correlated to the respective failure symptoms satisfying the logic gates and the process ends.

Referring to exemplary table 1 below, controller 220 may include self-healing rules including fault conditions, failure symptoms, corrective measures, and root causes. The self-healing rules may be applied by the system (e.g., controller 220 or incident management device 145), which may be performed by controller 220 without requiring connectivity to incident management device 145 or in response to an exemplary alarm from incident management device 145. In response to a fault condition (e.g., loss of connectively), the system may apply self-healing rules, as shown in table 1 below, may associate fault conditions with failure symptoms, corrective measures, and root causes. Further, the trouble ticket may be enriched with failure symptoms indicating the root cause of the fault condition.

For example, top level fault conditions may be generated in response to an outage. In response, the system may perform the fault tree analysis of process 900 to associate the detected fault condition with measured failure symptoms and, depending on the measured failure symptoms, use table 1 below to execute corrective measures and identify root causes of the system issue. For example a service outage may be associated with a parent event (e.g., network wide outage) or a system issue associated with a fault condition included in the self-healing rules, which may be repaired by the self-healing rules. Thus, in response to a fault condition detected, the system may execute process 900 to associate a fault condition with one or more failure symptoms, which the system (e.g., controller 220 or incident management device 145) may use to execute appropriate corrective measures and identify root causes as described further in table 1 below.

TABLE 1
Exemplary Self-Healing Rules

| Fault Condition | Failure Symptom | Corrective measures | Root Cause |
|---|---|---|---|
| Detected | Measured | Executed | Identified |
| Router Rommon | Last digit of the boot | 1) Set value in | CPE networking |
| on CPE | field in the configuration | configuration register to | device 120 |
| networking | register of CPE | 0x2102 and/or | failed to reload |
| device 120 | networking device 120 is | 2) reset or power-cycle | correctly after |
| | 0 (e.g., 0x100 or 0x0) | CPE networking device | power failure or |
| | | 120 | reboot |
| Loss of | No input or output | 1) Toggle up or down port | Network |
| connectivity | packets counting on | of CPE networking device | synchronization |
| | PTT/LEC NTU 115 | 120 and/or | issue |
| | | 2) Toggle Ethernet duplex | |
| | | setting of CPE networking | |
| | | device 120 | |
| Loss of | BGP active or down | Reset BGP session | Network |
| connectivity | | | synchronization |
| | | | issue |
| Loss of | Crypto session or device | 1) Reload crypto device | Network |
| connectivity | of automated incident | and/or | synchronization |
| | management system 145 | 2) clear crypto session | issue |
| | not passing traffic | | |
| Router reload | 1) Uptime of CPE | Restart CPE networking | Router software |
| | networking device 120 is | device 120 if not restarted | issue |
| | less than a predefined | automatically | |
| | number of minutes | | |
| | and/or | | |
| | 2) Crash file on flash | | |
| | memory of CPE | | |
| | networking device 120 | | |
| Intermittent | Status toggling of CPE | 1) Toggle Ethernet duplex | Network |
| connectivity | networking device 120 or | settings on CPE | synchronization |
| | PTT/LEC NTU 115 | networking device 120 | issue |
| | | and/or | |
| | | 2) Reboot interfacing | |
| | | equipment, e.g., PTT/LEC | |
| | | NTU 115 | |
| No traffic | MTU size mismatch | 1) Check MTU on | Configuration |
| passing with | between PTT/LEC NTU | PTT/LEC NTU 115 | issue or mistake |
| interface and | 115 and CPE Networking | and/or | |
| protocol both up | Device 120 | 2) adjust MTU settings on | |
| | | CPE networking device | |
| | | 120 | |
| No traffic | Remote alarm on | 1) Reboot PTT/LC NTU | Third-party |
| passing with | interface, e.g., PTT/LEC | 115 | supplier network |
| interface up but | network 110 such as an | 2) If remote device | access issue |
| protocol down | AIS cloud | indicates remote alarms, | |
| | | create and send trouble | |
| | | ticket to PTT/LEC | |
| No traffic | Recent configuration | Restore last known | Incorrect |
| passing | change detected on CPE | working configuration to | configuration |
| | networking device 120 | the CPE Networking | applied |
| | by controller 220 or | Device 120 | |
| | incident management | | |
| | device 145 | | |

Table 1 provides exemplary operations performed by controller 220 or incident management device 145. As an example, incident management device 145 may generate a top level alarm in response to a fault condition, for example loss of connectivity. The controller 220 or incident management device 145 may be configured to log into and check the log information from CPE networking device 120. The log information may indicate a failure symptom indicating that there is no input or output packets accumulating on CPE networking device 120, as there should be border gateway protocol (BGP) keep-alive packets counting on CPE networking device 120. In response to the failure condition, the system may execute corrective measures, for example, including administratively bringing down and bringing up the port (“bouncing the port”) of CPE Networking Device 120. Bouncing the port resets the line protocol, which may return service to the system. With respect to any type or combination of system issues, the system (e.g., controller 220 or incident management device 145) may be configured to detect fault conditions, measure failure symptoms, execute corrective measures, and identify root causes.

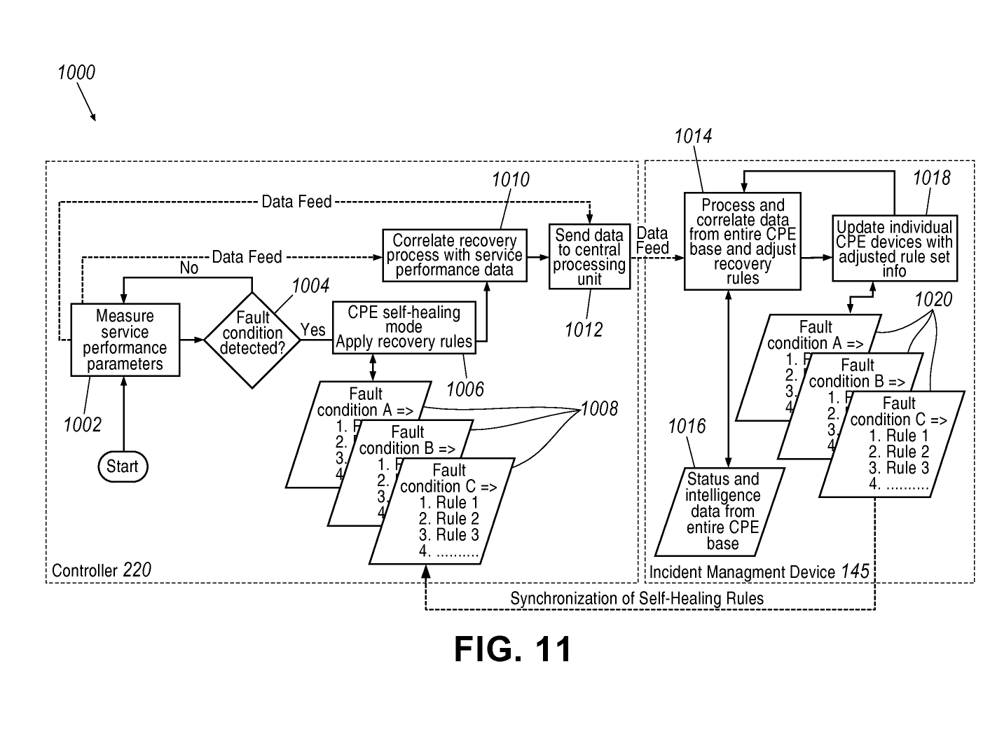

FIG. 11 illustrates an exemplary process 1000 for a self-healing mode of the system. Process 1000 may be performed by a controller 220 and an incident management device 145 configured to manage a plurality of customer sites and associated customer equipment devices. The customer equipment devices may include one or more of a MSE device 205, a MSR device 305a or 305b, a MSE device 405, a CPE networking device 120, and a PTT/LEC NTU 115 at a customer site in communication with an incident management device 145.

Exemplary process 1000 may be executed by the system (e.g., controller 220 of MSR device 305b) in response the failure symptoms and fault conditions, examples provided in process 900 and table 1 above. Controller 220 may be controlled by a set of initial self-healing rules on controller 220. The self-healing rules may be adjusted by incident management device 145, example provided in process 850 above. The self-healing rules may be tuned for a particular CPE networking device 120, for example based on the prior history of corrective measures associated with historical trouble tickets 150.

At block 1002, controller 220 may measure service management information from the system to determine a service status.

At block 1004, controller 220 may determine if a fault condition is detected. If a fault condition is detected, controller 220 may perform self-healing. Controller 220 may also periodically re-measure the performance parameters.

At block 1006, controller 220 may perform self-healing by applying the self-healing rules to the system.

At block 1008, the self-healing rules are applied to the system based on any number of particular fault conditions having respective sets of any number of repair rules. For example, exemplary fault conditions A, B, and C may each have corrective actions (e.g., see table 1 above) defined in respective sets of self-healing rules 1, 2, and 3.

At block 1010, controller 220 may generate a self-healing correlation between successful corrective measures associated with particular fault conditions and failure symptoms, as described in exemplary process 900 and table 1 above. The self-healing correlations may be included in or separate from the service management information.

At block 1012, controller 220 may send the service management information (e.g., including service performance including and successful self-recovery rules) to the incident management device 145.

At block 1014, incident management device 145 may process and correlate the service management information (e.g., based in part on a success rate associated with the self-recovery rules) from a plurality of controllers 220 and adjust the business rules of incident management device 145.

At block 1016, service management information from the plurality of controllers 220 from a plurality of customer sites is received by incident management device 145.

At block 1018, adjusted self-healing rules for the plurality of controllers 220 are generated based on the adjusted business rules of incident management device 145.

At block 1020, adjusted repair-rules are propagated to the plurality of controllers 220 at the plurality of customer sites. After block 1020, each controller 220 evolves based on periodically or continually adjusted self-healing rules from incident management device 145.

As an example, CPE networking device 120 may be connected to a certain PTT/LEC NTU 115 that may historically have a fault condition (e.g., lockup) that has been previously resolved with a particular corrective measure (e.g., a reboot). Controller 220 may be configured with a set of initial self-healing rules, which controller 220 may utilize to recover service for the system, for example, with respect to customer equipment. For each instance in which controller 220 successfully recovers service, controller 220 may log the successful rule to incident management device 145.

Incident management device 145 may periodically obtain a site status and historical data from each of a plurality of controllers 220 from a plurality of customer sites. Incident management device 145 may correlate the historical data from the plurality of controllers 220 to adjust business rules of incident management device 145. Incident management device 145 may also generate correlations between fault conditions, for example, based on device types, interconnected third-party party carriers, access technology type, failure rate conditions, and geographic area. Incident management device 145 may propagate adjusted self-healing rules to the plurality of controllers 220, for example, based on the correlations. The adjusted self-healing rules may include preferred corrective measures for particular fault conditions, for example, to be applied by each controller 220 in for future self-healing actions. For example, controller 220 may adapt its self-healing rules thereby learning optimized corrective actions for fault conditions based on the collective historical data of the plurality of controllers 220. The correlations generated by incident management device 145 propagates the continually adjusted self-healing rules, thereby distributing successful corrective measures learned from individual controllers 220 at particular customer sites to the plurality of controllers 220.

As the adjusted self-healing rules are refined, more self-healing knowledge may be propagated to each controller 220. The adjusted self-healing rules may refine the prioritization and statistical accuracy for corrective measures. For example, controller 220 may be configured to order a new replacement device with respect to any portion of the system if the self-healing rules fail to recover service or if a hardware failure is detected. Controller 220 or incident management device 145 may also be configured to track success rates and probabilities associated with self-healing corrective measures and the associated root causes.

In addition to recovery from fault conditions, controller 220 may be configured to optimize the system with respect to a desired or maximum performance level. For example, controller 220 may be configured to change quality of service (QoS) or bandwidth settings in response to a performance threshold, for example, by measuring packet discards or latency. As a further example, controller 220 may be configured to optimize the configuration of any portion of the system based on a service license agreement (SLA), for example, to minimize fees and customer dissatisfaction. In addition, these optimization features may be offered as an service enhancement with respect to a base level of managed services.

By the customer equipment having controller 220, the self-healing corrective measures may be implemented independently of the status of incident management device 145. Adjusted self-healing rules may be generated by incident management device 145 from the plurality of controllers 220, but each controller 220 may perform self-healing rules even in the event that incident management device 145 is experiencing system issues (e.g., connectivity issues with service provider network 105). Controller 220 may be configured to implement self-healing rules at the particular customer site absent connectivity to incident management device 145. Thus, controller 220 may be configured to recover connectivity at the customer site despite loss of connectivity with service provider network 105.

Incident management device 145 may be configured to exclude particular controllers 220 or customer sites from propagation of self-healing rules. For example, particular customer sites may adhere to other business rules or may be undergoing maintenance. Particular customer sites may have defined preferences defining allowed corrective measures, for example, certain corrective measures with respect to a particular CPE networking device 120. Particular customer sites may have defined preferences allowing a system restart but not power cycling of CPE networking device 120 to preserve log information. In addition, particular customer sites may have cancelled service or may be intentionally disconnected from PTT/LEC network 110 or service provider network 105.

Controller 220 may further be configured to initiate a reset. The reset may revert controller 220 to factory settings, for example, to reduce instability to a number of self-healing activities. The reset may be initiated after a predefined period of time or number of trouble tickets. The reset may be initiated after a number of independent technicians have tried to service the system. The reset may be initiated after a customer has restarted customer equipment or reseated the associated cables. In addition, the restart may be initiated in accordance with industry or design standards, for example, at regular intervals to limit memory leaks.

In addition to managed services and wide area networks, self-healing capabilities may be implemented into any computer system that may be subject to fault conditions. For example, self-healing may be utilized in systems having comparable components, for example routers, firewalls, and voice gateways. Self-healing may also be utilized for network function virtualization (NFV) and cloud computing systems. Further, self-healing may be implemented into a service demarcation device or service multiplexor. Implementation of self-healing may reduce down-time and increase operational efficiency for any computer system.

Self-healing systems may be utilized in conjunction with or as an alternative to a level of redundancy in typical network systems. For example, self-healing systems may supplement or replace redundancies such as dual power supplies, dual customer premises equipment, geographically diverse access, and dual network ports. Self-healing systems may also be used in combination with fail-over mechanisms such as stand-by computing systems or network connections. Self-healing system may correlate frequently occurring fault conditions to automatically implement corrective measures thereby reducing the need for system redundancies. Self-healing capabilities may expedite recovery while reducing redundant components.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system comprising:
at least one controller including a controller processor with a memory configured to execute self-healing rules, the self-healing rules including at least one corrective measure and at least one failure symptom;
an automated incident management device including a central processor with a memory to:
receive service management information from the at least one controller;
correlate at least one corrective measure with at least one failure symptom;
adjust the self-healing rules based on the correlation; and
propagate the adjusted self-healing rules to the at least one controller.

2. The system of claim 1, wherein the at least one failure symptom includes a degradation indicated by service performance information.

3. The system of claim 1, wherein the correlation is based in part on a fault tree analysis including a plurality of logic gates associating the at least one fault condition with at least one measured failure symptom.

4. The system of claim 1, wherein the service management information includes historical repair data of at least one controller including at least one corrective measure associated with a successful repair of the at least one fault condition.

5. The system of claim 1, wherein the correlation is based on historical repair data of at least one controller.

6. The system of claim 1, wherein the adjusted self-healing rules are propagated to a plurality of controllers.

7. The system of claim 1, wherein the automated incident management device is configured to receive service management information from a plurality of controllers.

8. An automated device manager comprising:
an automated incident management device including a central processor with a memory configured to:
receive, from a at least one remote controller, service management information including self-healing rules, the self-healing rules including at least one corrective measure and at least one failure symptom;
correlate at least one corrective measure with at least one failure symptom using the service management information from the at least one remote controller;
adjust the self-healing rules based on the correlation; and
propagate the adjusted self-healing rules to a plurality of remote controllers.

9. The device manager of claim 8, wherein the automated incident management device is located at a service provider site and the plurality of remote controllers are located at a plurality of customer sites.

10. The device manager of claim 8, wherein the at least one failure symptom includes a degradation indicated by service performance information.

11. The device manager of claim 8, wherein the correlation is based in part on a fault tree analysis including a plurality of logic gates associating the at least one fault condition with at least one measured failure symptom.

12. The device manager of claim 8, wherein the service management information includes historical repair data of at least one remote controller including at least one corrective measure associated with a successful repair of the at least one fault condition.

13. The device manager of claim 8, wherein the correlation is based on historical repair data of the least one remote controller.

14. The device manager of claim 8, wherein the automated incident management device is configured to receive service management information from the plurality of remote controllers.

15. A method comprising:
receiving service management information including self-healing rules from a plurality of remote locations, the self-healing rules including at least one corrective measure and at least one failure symptom;
correlating, from at least one remote location, at least one corrective measure with at least one failure symptom;
adjusting the self-healing rules based on the correlation; and
propagating the adjusted self-healing rules to the plurality of remote locations.

16. The method of claim 15, further comprising generating an alarm indicating at least one fault condition in response to a trouble ticket.

17. The method of claim 15, wherein the correlation is based in part on a fault tree analysis including a plurality of logic gates associating the at least one fault condition with at least one measured failure symptom.

18. The method of claim 15, wherein the service management information includes historical repair data of at least one controller including at least one corrective measure associated with a successful repair of the at least one fault condition.

19. The method of claim 15, wherein the correlation is based on historical repair data of at least one controller.

20. The method of claim 15, further comprising receiving service management information from a plurality of controllers.
